(19) United States
(12) Patent Application Publication
(10) Pub. No.: US 2012/0142562 A1
(43) Pub. Date: Jun. 7, 2012

(54) ORGANIC SALTS FOR REDUCING STONE PERMEABLITIES

(76) Inventors: Christian Spindler, Ludwigshafen (DE); Norbert Schleifer, Bremen (DE); Gregor Brodt, Heppenheim (DE)

(21) Appl. No.: 13/384,660

(22) PCT Filed: Jun. 14, 2010
(86) PCT No.: PCT/EP2010/058304

§ 371 Date: Feb. 17, 2012

(30) Foreign Application Priority Data
Aug. 12, 2009 (EP) 09167703.9

(51) Int. Cl. C09K 8/58

(52) U.S. Cl. 507/240; 507/263; 507/239; 507/250; 507/244; 507/251; 507/249

(57) ABSTRACT

The use of free, aromatic acids which contain at least two aromatic ring systems or at least two acid functions, and/or salts thereof, for influencing rock formations in the exploitation of underground mineral oil and/or natural gas deposits is described. The free acids are used in particular for influencing and especially controlling the flow of acid into rock formations in so-called acidizing methods. Suitable salts of said aromatic acids serve for reducing the rock permeability and in particular reducing the inflow of water into the well bore. In addition to this use, corresponding methods are also claimed.

The present invention relates to the use of free aromatic acids having specific features for influencing rock formations in mineral oil or natural gas production.

In the exploitation of underground mineral oil and/or natural gas deposits, water often also emerges from the underground rock formations, in addition to the production of the desired hydrocarbon products. Usually, degrees of watering down with a water content of up to 95% can occur. In these cases, the concomitantly extracted water must be separated off from the fossil fractions in a complicated manner after leaving the well and then disposed of or reinjected.

For the abovementioned reasons, the mineral oil and natural gas industry is understandably interested in keeping the flow of so-called formation waters into the production well as small as possible. In this context, inter alia experiments were also undertaken with the aid of polymer systems to suppress the undesired flow of waters from underground formations into the mineral oil or natural gas production stream.

Thus, U.S. Pat. No. 4,617,132 describes a method for influencing the permeability of hydrocarbon-carrying underground formations. For this purpose, an aqueous mixture which contains, inter alia, a water-soluble anionic polymer having a molecular weight of >100000 is introduced into the underground formation. This anionic polymer is then brought into contact with a water-soluble cationic polymer for stabilization purposes. Polyvalent metal cations and a retardant anion, such as, for example, acetates, nitrilotriacetates, tetracitrates and phosphates, play a role here. After being forced into the rock pores, these polymer systems form, as a result of temperature influence, gels which reduce the further flow of the undesired water into the well.

U.S. Pat. No. 5,789,350 but also WO 82/02052 likewise describe gelling systems consisting of a polycarboxylate and a polyvalent salt as a crosslinker. According to said U.S. patent, the gel-forming composition comprises a polymer, such as, for example, carboxylate-containing polymers, and, as a crosslinker component, a polyvalent metal, such as, for example, zirconium, and moreover an agent for reducing the pH, such as, for example, carbon dioxide. Such compositions are prepared by combining the polymer and the metal compound and then introducing carbon dioxide. With such compositions, too, the permeability of underground formations is said to be influenced in a targeted manner by the formation of gels in regions having a high water flow rate. Said international patent application, too, describes water-soluble, crosslinkable polymer compositions and the use thereof in underground rock formations: the crosslinkable water-soluble polymer compositions described there contain a polymeric compound which has at least 2 amidocarbonyl groups in the molecule and a compound which has at least 2 formylamido groups in the molecule. The amidocarbonyl groups and formylamido groups react in the presence of acid with formation of bridge members, which in turn produce crosslinking.

In the present case, said polymer compositions are used in so-called fracture acidizing, which is a pressure acidizing method. With stimulation of wells with the aim of increasing the yield of mineral oil or natural gas from underground formations, use is frequently made of this pressure acidizing in relation to carbonate formations as represented by, for example, limestone, dolomite or other reservoir rocks comprising limestone-like materials. As a rule, the acidizing is carried out in such a way that aqueous acids are injected with a specific speed and a high pressure into the well so that the existing formation pressure in the rock is exceeded, the rock yields and in this way additional fractures are opened in the formation. In addition, the surfaces of the rock fractures are etched by the acids. The acidizing creates channels which have increased permeability for the fossil oil or gas, and these can therefore flow to an increased extent to the well. Often, thickeners or gelling agents are added to the acids used, in order thus to achieve larger fracture volumes or greater internal widths of the fracture. Moreover, the etching rate on the surfaces of the formations can be controlled by the addition of such auxiliary liquids, the viscous acids having better transport behaviour compared with other additives, such as, for example, proppants.

In relation to the stimulation of wells with the use of acids, however, so-called acid diverters are also used. These are said to prevent the penetration of relatively strong acids for stimulation purposes into permeable rock formations. Thus, WO 03/093641 A1 discloses an acid-thickening system. This system comprises aqueous, thickened acid compositions which, in addition to the acid component, also comprise a gel former, to which, for example, glycol, as a solvent, and at least one amidoamine oxide are added so that a viscoelastic liquid is obtained. In addition to thickening systems, however, acid-insoluble and scale-like substances which are capable of sealing relatively large or coarse-pored rock formations can be added to the acid. Such an example is described in U.S. Pat. No. 3,998,272. In this case, discrete solid particles of polyvinyl acetate are used as diverting agents in the pressure acidizing treatment of underground geological formations. Owing to their size, the scale-like solid particles penetrate exclusively into relatively porous rock formations and close these. The narrower pores remain open so that these narrower channels can be widened by acid-induced rock hydrolysis, as occurs in typical pressure acidizing methods.

Although numerous attempts have been made in the past to regulate or entirely to suppress the undesired flow of water into the producing well, there is still a need to improve existing methods or to provide novel alternatives. In particular, it was intended to overcome the known disadvantages, such as, for example, an unadapted solubility of the auxiliaries used in the hydrocarbons, in some cases very high costs with regard to the methods used and the auxiliaries used, insufficient reversibility of the processes in the rock formations and the insufficient selectivity of the methods and a low degree of temperature limitation in the case of most known systems.

For the present invention, said disadvantages have therefore led to the object of providing a novel chemical system for influencing rock formations in the exploitation of underground mineral oil and/or natural gas deposits. This novel system should in particular have economic advantages since the auxiliaries used in mineral oil and natural gas production are usually very important owing to their efficiency but the auxiliaries themselves must give rise only to low procurement and application costs. Moreover, the auxiliaries used should be substantially safe from ecological points of view and capable of displaying their efficiency in particular under the elevated temperature and pressure conditions and in the very different rock formations.

This object was achieved by the corresponding use of free aromatic acids which contain at least two aromatic ring systems or at least two acid functions and/or salts thereof.

Surprisingly, it was found that not only could said disadvantages be overcome and the object achieved but that, by the use of such compounds, the reduction of the flow of water into underground mineral oil and/or natural gas deposits can be controlled in a targeted manner and in particular can be substantially reduced thereby without it being necessary to add a further reactive component, such as, for example, gel formers.

The free aromatic acids are preferably at least one member of the series consisting of 2-naphthoic acid, phthalic acid, isophthalic acid or terephthalic acid. By using at least one member of these four stated acids or any desired mixtures thereof, it is possible, according to the invention, in particular to influence and preferably control the flow of acid into rock formations in so-called acidizing treatments (pressure acidizing treatments), It has been found to be particularly advantageous if the acids used are insoluble in the concentrated acids of the acidizing treatment.

Usually, the claimed use is independent of specific temperature and pressure conditions; however, in relation to the influencing of the flow of acid into rock formations in acidizing treatments, it has proved to be advantageous compared to currently used systems if the temperature range is ≧60° C., temperatures being a ≧80° C., in particular ≧130° C. and particularly preferably ≧150° C.

In relation to the use according to the invention in connection with acidizing treatments, it is possible, according to the present invention, for the acids to be dissolved after the acidizing treatment, which is preferably effected by the addition of organic amines and in particular of at least one member of the ethyleneamines, such as, for example, triethylamine, triethylenetetramine, triethylenepentamine, polyethyleneimine, or ethanolamines, such as, for example, triethanolamine. The dissolution of the acids can, however, also be effected by the fossil material, such as, for example, the crude oil itself, in particular the nitrogen-containing components present in the crude oil playing a substantial role.

In addition to influencing the inflow of acid, the present invention also comprises the use of the free aromatic acids for reducing the rock permeability and thereby in particular for reducing the inflow of water. Preferably, salts of the aromatic acids are suitable here, at least one member of the series consisting of alkali metal salts, inorganic or organic ammonium salts being suitable and in particular compounds whose ammonium ions are constituents of organic ammonium compounds, such as, for example, diethylenetriamine, triethylenetetramine or tetraethylenepentamine.

In addition to the use, the present invention also comprises a method for influencing and in particular controlling the flow of acid into rock formations in the exploitation of underground mineral oil and/or natural gas deposits in so-called acidizing treatments. In this method, at least one member of the free, aromatic acids which contain at least two aromatic ring systems or at least two acid functions, and in particular at least one member of the series consisting of 2-naphthoic acid, phthalic acid, isophthalic acid or terephthalic acid, are pumped into the rock formation to be treated, particularly preferably with addition of viscosity-increasing additives, such as, for example, polymers or viscoelastic surfactants. Examples of suitable viscoelastic surfactants having an ionic character are alkylcarboxylates, alkyl ether carboxylates, alkylsulfates, alkyl ether sulfates, alkanesulfonates, alkyl ether sulfonates, alkylphosphates and alkyl ether phosphates. Cationic surfactants are alkylamines, alkyldiamines, alkyl ether amines, alkyl quaternary ammonium, dialkyl quaternary ammonium and ester quaternary ammonium compounds. Viscoelastic surfactants can, however, also have a zwitterionic character or amphoteric properties. Alkylbetaines, alkylamidobetaines, alkylamidazolines, alkylaminooxides and alkyl quaternary ammonium carboxylates may be mentioned here.

A further use according to the invention consists in the reduction of the rock permeability and in particular in the reduction of the flow of water through underground rock formations into the well bore during the exploitation of underground mineral oil and/or natural gas deposits. Here, at least one member of the salts of aromatic acids which contain at least two aromatic ring systems or at least two acid functions and in particular alkali metal salts, ammonium salts and organoammonium salts are pumped into the rock formation to be treated, particularly preferably without addition of further reactive components. In this context, the acids are at least one member of the series consisting of 2-naphthoic acid, phthalic acid, isophthalic acid or terephthalic acid.

In said methods according to the invention, salts of the aromatic acids are pumped into the rock formation to be modified. By mixing the salt solution with the formation waters, which usually contain cations of relatively high valency, such as, for example, alkaline earth metal, aluminium or iron ions, the chosen organic salts are irreversibly precipitated and can no longer be brought into solution even by increasing the ambient temperature. In contrast to currently used polymer systems the system of the invention is suitable to block water influx through low permeability rock formations.

According to the invention, the use of the free corresponding acids is used for controlling the flow of acid into rock formations in acidizing treatments. For this purpose, the salt solutions described are pumped into the rock formation to be treated, if appropriate with addition of viscosity-increasing additives. Owing to the viscosity of the treatment fluid, the salt solution preferably enters the parts of the rock formation which have increased permeability. As soon as the hydrochloric acid usually used in acidizing treatments is subsequently pumped and comes into contact with the salt solution present there, the dissolved salt of the organic acid is protonated and is precipitated. The permeability of the rock formation is thus likewise reduced and further amounts of acid cannot penetrate into the rock.

As already mentioned, it has proved to be advantageous if the free acids corresponding to the salts are insoluble in concentrated acids as are used for pressure acidizing treatments. While the systems described to date in the literature and based on benzoic acid can be used up to a maximum formation temperature of 80° C. owing to the low melting point of benzoic acid, the systems according to the invention are effective to far above 150° C. For this purpose, the free acid is added to the acidizing fluid in scale form in order to seal coarse pore rock formations to prevent the entry of acid. The scales may cover a relatively broad particle size range and may be between 3 and 100 mesh. Scale sizes between 8 and 12 mesh and in particular between 12 and 20 mesh are preferred, it not being necessary for the size to be uniform but it being permitted for the size to cover said ranges in different fractions.

When the said acids are used according to the invention in the acidizing area, it is in most cases essential to redissolve the free, aromatic acids after the acid treatment, in order to ensure the free admission of the hydrocarbon to be extracted into the well. This dissolution is effected according to the invention by the addition of organic amines or by nitrogen-containing components of the crude oil itself.

The following examples illustrate the advantages of the present invention without limiting said invention thereto.

### EXAMPLES

### Preparation Examples:

1. 200 g of terephthalic acid were suspended in 400 ml of water. Thereafter, neutralization was effected with about 115 g of tetraethylenepentamine until a pH of 7 was reached.

2. 200 g of isophthalic acid were suspended in 400 ml of water and adjusted to a pH of 7 with about 135 g of tetraethylenepentamine.

3. 200 g of 2-naphthoic acid were suspended in 400 ml of water and adjusted to pH 7 with 56 g of tetraethylenepentamine.

### Use Examples:

1. Reduction of the rock by polyvalent cations for controlling the admission of water into the well:

Gildehaus sandstone having a porosity of 20.3% and a gas permeability of 2285 mD and an initial water permeability of 2043 mD was impregnated with formation water (4.26% of CaCl₂, 1.05% of MgCl₂, 110 ppm of NaHCO₃, 270 ppm of NaSO₄, 380 ppm of NaBO₂xH2O). Thereafter, the sandstone sample was treated in a Hasser cell with a 10% strength solution of sodium terephthalate and at a flow rate of 1 ml/h. A volume of 4 ml (38% of the pore volume) were pumped. The temperature was 50° C. Thereafter, the sample was treated with 2.5 ml/h of formation water and the system was left to stand for 15 h and then treated again with 1 ml/h of formation water. Thereafter, formation water and salt solution were fed in alternately with a flow rate of 1 ml/h and then treatment was effected again with a pore volume of the salt solution described in Preparation Example 1. The water permeability of the rock decreased by 78%.

2. Precipitation by addition of acid for controlling the flow of acid into the formation during the acidizing:

Concentrated hydrochloric acid solution was added to the salt solutions prepared according to Preparation Examples 1 to 3. All three compounds precipitated thereby. The suspensions were heated to 90° C. in order to determine whether the precipitated organic acids go into solution again. Significant dissolution of the free acids at this temperature was not observable.

3. Dissolution of the free acid by washing with organic amine:

40 g of concentrated hydrochloric acid were added to 20 g of the amine salt obtained according to Preparation Example 2. The precipitated free acid was washed with water and then suspended in 100 ml of water. 20 g of tetraethylenepentamine were added and stirring was then effected for 20 min at 60° C. The precipitate dissolved completely.

1-11. (canceled)

12. A method comprising injecting free, aromatic acids which contain at least two aromatic ring systems or at least two acid functions, or the salts thereof, into at least one of an underground mineral oil or a natural gas deposit in an amount sufficient to influence a rock deposit in said mineral oil or natural gas deposit.

13. The method according to claim 12, wherein the free acids are at least one member of the series consisting of 2-naphthoic acid, pththalic acid, isophthalic acid or terephthalic acid.

14. The method according to claim 13, wherein said influencing is controlling flow of acid into rock formations in an acidizing treatment.

15. The method according to claim 14, wherein the acids are insoluble in concentrated acids used for the acidizing treatment.

16. The method according to claim 14, in the temperature range ≧60° C.

17. The method according to claim 14, in the temperature range ≧80° C.

18. The method according to claim 14, in the temperature range ≧130° C.

19. The method according to claim 14, in the temperature range ≧150° C.,

20. The method according to claim 15, in the temperature range ≧60° C.

21. The method according to claim 15, in the temperature range ≧80° C.

22. The method according to claim 15, in the temperature range ≧130° C.

23. The method according to claim 15, in the temperature range ≧150° C.

24. The method according to claim 14, wherein the acids are dissolved after the acid treatment.

25. The method according to claim 24, wherein the acids are dissolved by adding an organic amine.

26. The method of claim 25, wherein the organic amine is selected from the group consisting of an ethyleneamine and an ethanolamine,

27. The method of claim 24, wherein said organic amine is selected from the group consisting of triethylamine, triethylenetetramine, triethylenepentamine, polyethyleneimine and triethanolamine.

28. The method according to claim 12, wherein rock permeability of rocks in the underground mineral oil or the natural gas deposit is reduced.

29. The method according to claim 12, wherein inflow of water into the underground mineral oil or the natural gas deposit is reduced.

30. The method according to claim 12, wherein the salts are at least one member selected from the group consisting of an alkali metal salt, an inorganic ammonium salt and an organic ammonium salt.

31. The method according to claim 12, wherein the salts are organic ammonium salts of at least one member selected from the group consisting of diethylenetriamine, triethylenetetramine and tetraethyl enepentamine.

32. A method for controlling the flow of acid into a rock formation in the exploitation of at least one of an underground mineral oil or natural gas deposit by applying an acidizing treatment to the rock formation by pumping at least one member of a free, aromatic acid which contains at least two aromatic ring systems or at least two acid functions into the rock formation.

33. The method of claim 32, wherein the acid is selected from the group consisting of 2-naphthoic acid, phthalic acid, isophthalic acid and terephthalic acid.

34. The method of claim 32, wherein the acid treatment further comprises a viscosity-increasing additive.

35. A method for reducing rock permeability in rock found in an underground mineral oil or natural gas deposits, wherein at least one salt of an aromatic acid which contain at least two aromatic ring systems or at least two acid functions are pumped into the rock formation to be treated without addition of further reactive components.

36. A method according to claim 35, wherein the acid is selected from the group consisting of 2-naphthoic acid, phthalic acid, isophthalic acid and terephthalic acid.
